(19) United States
(12) Patent Application Publication
(10) Pub. No.: US 2005/0223548 A1
(43) Pub. Date: Oct. 13, 2005

(54) Cable connector compression tool

(76) Inventor: C.J. Chen, Taipei (TW)

Correspondence Address: BIRCH STEWART KOLASCH & BIRCH, PO BOX 747, FALLS CHURCH, VA, 22040-0747, US

(21) Appl. No.: 10/819,145

(22) Filed: Apr. 7, 2004

(51) Int. Cl. H01R 39/00

(52) U.S. Cl. 29/747; 439/106; 29/758

(57) ABSTRACT

A cable connector compression tool includes a left handle and a right handle that are pivotally engaged with each other. The right handle is at a first position spaced from the left handle at a selected distance in normal conditions, and may be moved close to the left handle at a second position. It also has a compression dock which includes a first member, a second member and a housing member. The housing member is located in the first and second member to allow the second member to slide linearly and reciprocally in the first member. When the right handle is moved from the first position to the second position, the second member is driven to compress the cable located in the housing member, or stripping and cutting operations may be performed through a cutter seat and a stripping seat located on the left handle and the right handle.

### FIELD OF THE INVENTION

The present invention relates to a cable connector compression tool and particularly to a composite tool to perform stripping, cutting and compression operations to couple a cable connector with a cable.

### BACKGROUND OF THE INVENTION

Cables are widely used for signal transmission. For instance data transmission lines used in computer equipment are cables. In order to facilitate connection of the cables to the equipment, the cable usually has a distal end coupled with a cable connector. In the past the cable connector usually included a plastic seat and a wire clamping member. The cable had an outer insulation layer which was stripped, and the remain of the cable was inserted in the plastic seat, then they were clamped by the wire clamping member to fasten the cable connector to the cable. Many cable compression tools have been developed to do a cable compression task.

The cable generally has, from outside to inside in this order, an outer insulation layer, an inner insulation tube and a central conductive wire. The process for fastening the cable and cable connector includes, first, cutting the cable at a desired length through a cutter; stripping the outer insulation layer and the inner insulation tube in a stepwise manner to expose the central conductive wire; coupling the cable connector to the stripped cable; finally fastening the cable connector to the cable through a special tool.

In the fastening process set forth above, many special tools have to be used. It creates a lot of trouble for workers, and cannot meet the requirements of workers.

### SUMMARY OF THE INVENTION

Therefore the primary object of the invention is to provide a composite cable connector compression tool to perform stripping, cutting and compression operations.

The cable connector compression tool according to the invention includes a left handle, a right handle and a compression dock. The right handle is pivotally coupled with the left handle in a movable manner and is spaced from the left handle for a selected distance at a first position in normal condition, and also may be moved close to left handle at a second position. The compression dock includes a first member, a second member and a housing member. The housing member is located in the first and second member. The second member is movable linearly and reciprocally relative to the first member. The housing member has an opening on one side normal to the right handle and close to the left handle to receive a cable from outside. The second member has a compression section in the sliding direction corresponding to the housing member. The first member has a first slot to pivotally couple with left handle. The second member has a second slot to pivotally couple with the right handle. In addition, the left handle and the right handle have a cutter seat and a stripping seat on the inner sides that face each other. When the right handle is moved close to the left handle at the second position, the cable located in the cutter seat, stripping seat or housing member may be cut off, stripped or compressed, thereby providing various operations required to fasten the cable connector and the cable.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1A is an exploded view of the compression dock of the cable connector compression tool according to the invention.

FIG. 1B is a perspective view of the compression dock of the cable connector compression tool according to the invention.

FIG. 2 is an exploded view of the cable connector compression tool according to the invention, including handles, cutter seat, and stripping seat.

FIG. 3 is a perspective view of the cable connector compression tool according to the invention.

FIG. 4 is a schematic view of the invention with the handles at the first position.

FIG. 5 is a schematic view of the invention with the handles at the second position.

### DESCRIPTION OF THE PREFERRED EMBODIMENTS

The cable connector compression tool according to the invention is for coupling a cable with a cable connector and providing cutting, stripping and compressing operations. The cable generally has, from outside to inside in this order, an outer insulation layer, an inner insulation tube and a central conductive wire. Before fastening the cable and cable connector, the cable is cut at a desired length through the cutting seat, then the outer insulation layer and inner insulation tube are stripped through the stripping seat in a stepwise manner to expose the central conductive wire, finally the cable connector is fastened to the cable through the compression dock by compressing, to complete the coupling process.

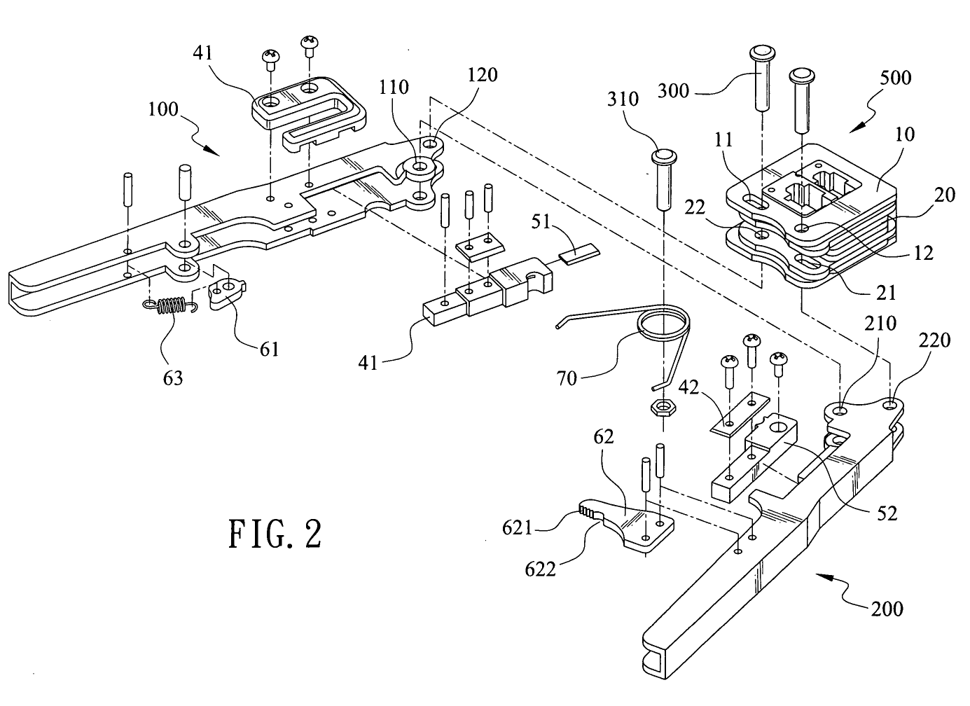

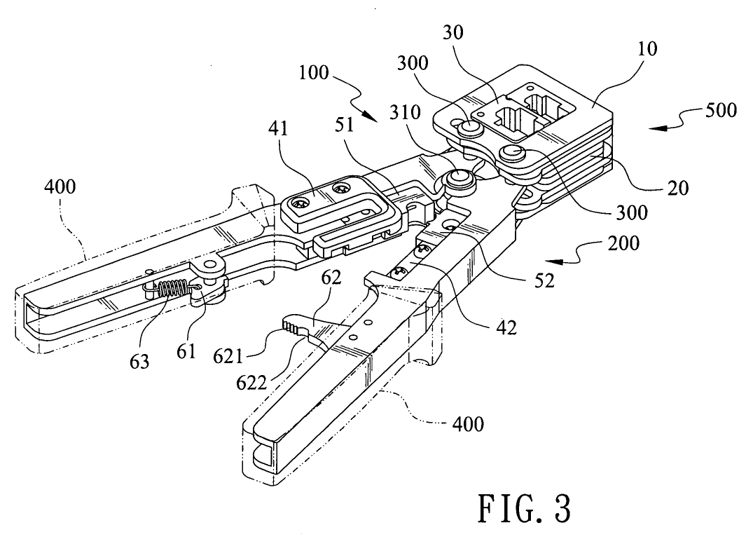

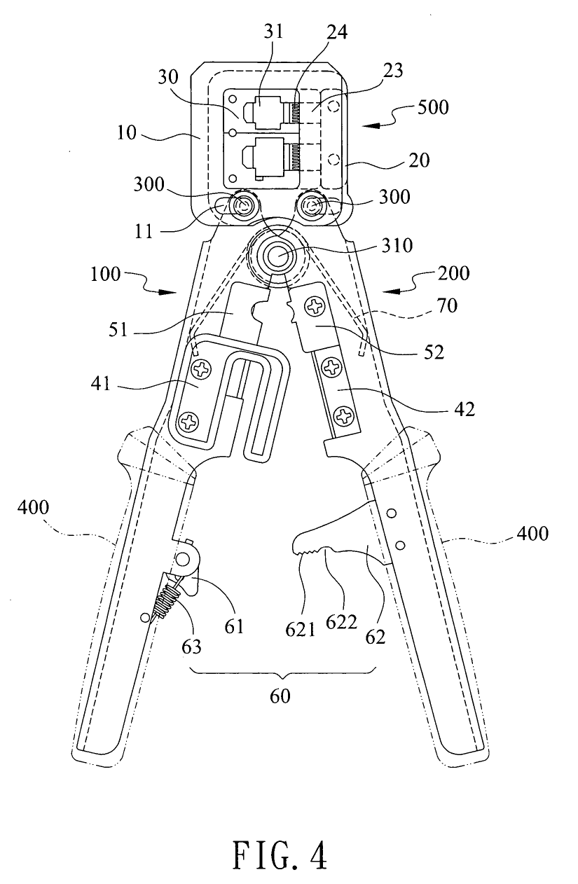

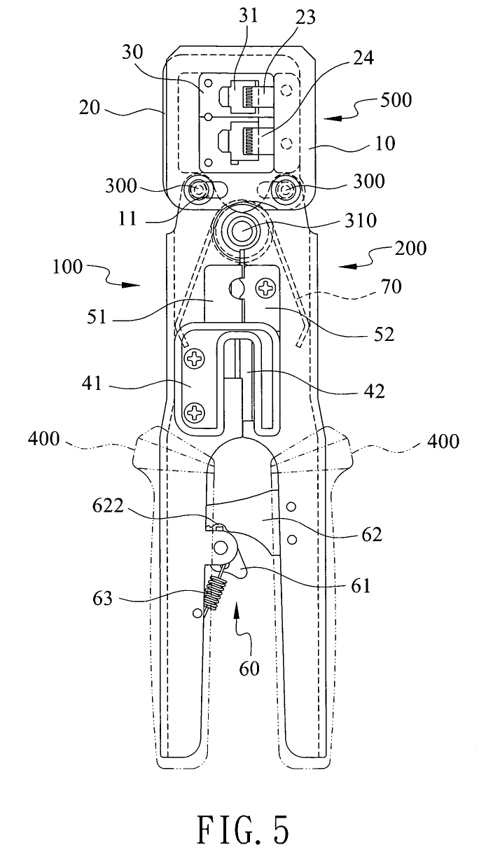

Refer to FIGS. 2 and 3, the cable connector compression tool according to the invention includes a left handle 100, a right handle 200 and a compression dock 500. The left handle 100 has a left pivot hole 110. The right handle 200 has a corresponding right pivot hole 210. An anchor pin 300 runs through the left and right pivot holes 110 and 210 to enable the left handle 100 and the right handle 200 to be pivotally coupled with each other in a movable manner. A returning element 70 is wedged between the left handle 100 and the right handle 200 to provide an elastic force to move the right handle 200 to a selected distance at a first position (referring to FIG. 4) in normal condition, or allow the right handle to be close to the left handle 100 at a second position (referring to FIG. 5). The returning element 70 may be formed in many styles as long as it can keep the right handle 200 at the first position. In the embodiment, a torsion spring is used. Of course this is not a limitation.

The left handle 100 and the right handle 200 have a distal end coupled with a grip sleeve 400 made from rubber to facilitate user gripping and switching between the first position and the second position of the right handle 200. In addition, the left handle 100 and the right handle 200 have a cutter seat 40 and a stripping seat 50 located on inner sides that face each other. The cutter seat 40 has a holding section 41 and a cutter blade 42 that are located respectively on the left handle 100 and the right handle 200. When a user presses the left handle 100 and the right handle 200 to move the right handle 200 to the second position, the cutter seat 40 can cut off the cable.

The stripping seat 50 also is located on the inner sides of the left handle 100 and the right handle 200 that face each other and are above the cutter seat 40. It has a compression section 51 and a blade 52. When the left handle 100 and the right handle 200 are moved away at the first position, the cable may be placed in the stripping seat 50. When the right handle 200 is moved close to the left handle 100, it can clamp and strip the outer insulation layer and inner insulation tube to expose the central conductive wire. Moreover, a phase assembly 60 is located on the inner sides of the left handle 100 and right handle 200 that face each other and are below the bottom of the cutter seat 40. The phase assembly 60 includes a stopper 61 and a hook 62 located respectively on the inner sides of the left handle 100 and the right handle 200 that face each other. The hook has a distal end forming a plurality of teeth 621 corresponding to the stopper 61, and a release notch 622 at the distal end of the hook where the teeth 621 are formed. When the right handle 200 is moved close to the left handle 100, the teeth 621 may be coupled with the stopper 61 to keep the right handle 200 to be close to the left handle 100 at a desired distance to facilitate stripping operation for cables of different sizes. When moving the stopper 61 to the release notch 622, the stopper is pushed by a spring 63 and turns to a selected angle. The latch condition with the hook 62 is released. The returning element 70 provides a compression elastic force to push the right handle 200 back to the first position to be spaced from the left handle 100 at the selected distance.

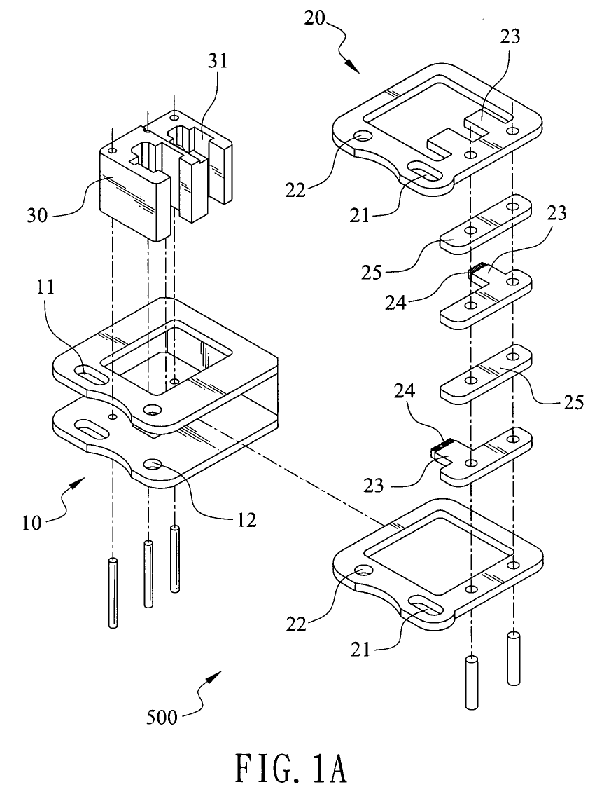

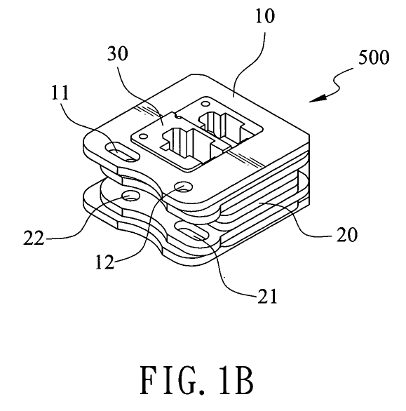

The compression dock 500 is located at the pivotal top end of the left handle 100 and the right handle 200. Referring to FIGS. 1A and 1B, it mainly includes a first member 10, a second member 20 and a housing member 30. The first member 10 has a first slot 11 and a first pin hole 12. The second member 20 is located in the first member 10 and is movable linearly and reciprocally therein, and has a second pin hole 22 corresponding to the first slot 11 and a second slot 21 corresponding to the first pin hole 12. The housing member 30 is located in the first and the second members 10 and 20, and has an opening 31 formed on one side normal to the right handle 200 and close to the left handle 100 to receive a cable from outside. The second member 20 has a compression section 23 in the sliding direction corresponding to the housing member 30. The compression section 23 has a plurality of teeth 24. The second member 20 further has a plurality of clamping members 25 which also have a compression section 23 with teeth 24 formed thereon. The clamping members 25 are adjustable according to requirements to match the compression position of the central wire of the cable to be fastened to the cable connector. For assembly, the anchor pin 300 runs through the first slot 11 of the first member 10, a first aperture 120 of the left handle 100, and the second pin hole 22 of the second member 20 to fasten the left handle 100 to the second member 20. Similarly, another anchor pin 300 may run through the first pin hole 12 of the first member 10, a second aperture 220 of the right handle 200 and the slot 21 of the second member 20 to connect the right handle 200 to the first member 10. Thus the left handle 100 and the right handle 200 may be moved close to each other or extended and opened to drive the second member 20, sliding linearly and reciprocally in the first member 10.

Referring to FIGS. 4 and 5, a cable connector and a cable may be placed in the compression dock 500 through the opening 31 of the housing member 30. Then grip the left handle 100 and the right handle 200 to move the right handle 200 from the first position (FIG. 4) to the second position (FIG. 5), and the second member 20 may be driven to move the compression section 23 in the direction of the housing member 30 to compress the cable.

In summary, the cable connector compression tool according to the invention can simultaneously cut, strip and compress the cable to perform coupling operations. Thus a single tool can provide a plurality of functions without using many special tools. The phase assembly 60 can control the opening condition of the left handle and the right handle, and dynamically adjust the force applying position to suit cables of varying sizes. The opening 31 of the housing member 30 is normal to the gripping direction of the user's hand on the left handle 100 and right handle 200. Hence the user can use one hand to grip and control, while another hand holds the cable for operation. This is a user-friendly operation, and versatile and convenient.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments, which do not depart from the spirit and scope of the invention.

1. A cable connector compression tool, comprising:
a left handle and a right handle pivotally coupled to the left handle, the right handle being located at a first position spaced from the left handle at a selected distance in normal conditions, and movable close to the left handle at a second position; and
a compression dock including a first member, a second member located in the first member and a housing member located in the first member and the second member to allow the second member sliding linearly and reciprocally in the first member, the housing member having an opening on one side to receive a cable from outside, the second member having a compression section in the direction of sliding corresponding to the housing member, the first member having a first slot to pivotally couple with the left handle, the second member having a second slot pivotally couple with the right handle;
wherein the second member is driven to move the compression section to compress the cable located in the housing member when the right handle is moved from the first position to the second position.

2. The cable connector compression tool of claim 1, wherein the first member has a first pin hole corresponding to the second slot to receive an anchor pin for the right handle to couple with the first member.

3. The cable connector compression tool of claim 1, wherein the second member has a second pin hole corresponding to the first slot to receive another anchor pin for the left handle to couple with the second member.

4. The cable connector compression tool of claim 1 further having a cutter seat which consists of a cutter blade and a holding section located respectively on an inner side of the left handle and the right handle that face each other to cut the cable when the right handle is moved towards the left handle.

5. The cable connector compression tool of claim 1 further having a stripping seat which consists of a blade and a compression section located respectively on an inner side of the left handle and the right handle that face each other to strip the cable when the right handle is moved towards the left handle.

6. The cable connector compression tool of claim 1 further having a stopper and a hook located respectively on an inner side of the left handle and the right handle that face each other to couple with each other when the right handle is moved towards the left handle to keep the left handle and the right handle to be spaced from each other at a selected distance.

7. The cable connector compression tool of claim 6, wherein the hook has a plurality of teeth to control the spaced distance between the left handle and the right handle.

8. The cable connector compression tool of claim 1, wherein the left handle and the right handle have respectively a distal end coupling with a grip sleeve to facilitate user gripping and applying forces.

9. The cable connector compression tool of claim 8, wherein the grip sleeve is made from rubber.

10. The cable connector compression tool of claim 1 further having a returning element coupled with the left handle and the right handle to provide a returning elastic force to the right handle to keep the right handle at the first position in the first position.

11. The cable connector compression tool of claim 10, wherein the returning element is a torsion spring.

12. The cable connector compression tool of claim 1, wherein the compression section has a plurality of teeth.
